(19) United States
(12) Patent Application Publication
(10) Pub. No.: US 2007/0036201 A1
(43) Pub. Date: Feb. 15, 2007

(54) Storage appliance having temperature sensing arrangement and control method thereof

(75) Inventors: Woo Yeol Yoo, Gwangju-City (KR); Hee Suk Han, Gwangju-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/386,683

(22) Filed: Mar. 23, 2006

(30) Foreign Application Priority Data
Aug. 12, 2005 (KR) 10-2005-0074345

(51) Int. Cl. G01K 11/00

(52) U.S. Cl. 374/161; 374/120

(57) ABSTRACT

A storage appliance designed to sense a temperature variation of a storage container by the use of ink, which is applied to the storage container and changes color in accordance with the temperature variation. The storage appliance is able to control a temperature of the storage container to a proper value in accordance with the sensed temperature variation of the storage container. A discoloration material is applied to the storage container to change color in accordance with the temperature of the storage container, a temperature sensing unit detects a quantity of light received, which varies in accordance with the color of the discoloration material, to sense the temperature of the storage container, and a control unit estimates a temperature of the storage container when a voltage value, which corresponds to the received quantity of light, is transmitted from the temperature sensing unit to the control unit.

### CROSS-REFERENCE TO RELATED APPLICATIONS

This application claims the benefit of Korean Patent Application No. 10-2005-0074345, filed on Aug. 12, 2005 in the Korean Intellectual Property Office, the disclosure of which is incorporated herein by reference.

### BACKGROUND OF THE INVENTION

1. Field of the Invention

The present invention relates to a storage appliance for keeping a storage container cold. More particularly, to a storage appliance having a temperature sensing arrangement for sensing a temperature variation of a storage container by use of ink, which is applied to the storage container and changes color in accordance with the temperature variation, and a control method of the storage appliance.

2. Description of the Related Art

In general, a conventional refrigerator employs a conventional cooling system for circulating refrigerant therein. With the cooling system, liquid-phase refrigerant absorbs heat of the surroundings when it is evaporated, to produce cold air. As the cold air is supplied into a food storage compartment, it is possible to keep various foods fresh for a long period of time. Recently, a kimchi refrigerator has been developed and made widely available to ripen and preserve kimchi by use of such a cooling system and electric heater.

A storage appliance including a refrigerator or a Kimchi refrigerator, is provided with one or more storage containers, for example, Kimchi vessels. The storage containers are separably received in the food storage compartment, and are maintained at a proper temperature in a state of being filled with food, respectively, so that the food can be stored fresh for a long period of time.

Conventionally, to maintain the storage container of the storage appliance at a proper temperature, there has been employed a method using a sensor adapted to detect a resistance value in accordance with a temperature variation. The sensor is installed at a desired position, for example, a sidewall or bottom position of the storage compartment, to measure a temperature of the storage compartment and, consequently, to control a temperature of the storage container.

However, the conventional method for sensing the temperature of the conventional storage appliance has a problem in that installing the sensor reduces an available interior space of the storage compartment. Also, if a specific space includes a thermal insulating layer, the sensor has a difficulty in the measurement of a temperature.

When a plurality of storage containers are received in the storage compartment, the respective storage containers may exhibit different temperatures even in the same storage compartment in accordance with the kind or state of foods stored therein. However, the conventional storage appliance only has a function of controlling all the storage containers with the same temperature, and fails to satisfy quality enhancement and diversification demands of consumers.

### SUMMARY OF THE INVENTION

Accordingly, it is an aspect of the present invention to provide a storage appliance having a temperature sensing arrangement for sensing a temperature variation of a storage container by use of ink, which is applied to the storage container and changes color in accordance with the temperature variation, and a control method of the storage appliance.

Additional aspects and/or advantages of the invention will be set forth in part in the description which follows and, in part, will be apparent from the description, or may be learned by practice of the invention.

The foregoing and/or other aspects of the present invention are achieved by providing a storage appliance having a temperature sensing arrangement, which can control a temperature of a storage container to a proper value in accordance with a temperature variation of the storage container, and a control method of the storage appliance.

It is another aspect of the present invention to provide a storage appliance having a temperature sensing arrangement, the storage appliance including a storage compartment and a storage container separably received in the storage compartment, further including a discoloration material applied to the storage container to change color in accordance with a temperature of the storage container, and a temperature sensing unit mounted in the storage compartment, to detect the a quantity of light received, which varies in accordance with the color of the discoloration material, to sense the temperature of the storage container.

The discoloration material includes an ink film applied to a surface of the storage container.

The temperature sensing unit is installed at a position corresponding to the discoloration material.

The temperature sensing unit includes a light emitting element to emit light, and a light receiving element to detect the received quantity of light when the light, emitted from the light emitting element, is reflected by the discoloration material applied to the storage container to thereby be transmitted to the light receiving element.

The storage appliance further includes a display unit arranged on an outer surface of the storage appliance, and displaying the color of the discoloration material or a temperature value of the storage container.

The storage appliance further includes a control unit to estimate a temperature of the storage container when a voltage value, which corresponds to the received quantity of light, is transmitted from the temperature sensing unit to the control unit, and the control unit controls the temperature of the storage container in accordance with the estimated temperature of the storage container.

It is another aspect of the present invention to provide a storage appliance having a temperature sensing arrangement, including a storage compartment, the storage appliance further including a storage container separably received in the storage compartment, a discoloration material applied to the storage container to change color in accordance with a temperature of the storage container, a temperature sensing unit to detect a quantity of light received that varies in accordance with a color of the discoloration material, to sense the temperature of the storage container, and a control unit to estimate a temperature of the storage container when a voltage value, which corresponds to the received quantity of light, is transmitted from the temperature sensing unit to the control unit.

The temperature sensing unit is mounted to an inner surface of a door that opens and closes the storage compartment, and the temperature sensing unit includes a light emitting element to emit light, and a light receiving element to detect the received quantity of light when the light, emitted from the light emitting element, is reflected by the discoloration material applied to the storage container to thereby be transmitted to the light receiving element.

It is another aspect of the present invention to provide a control method of a storage appliance including a storage compartment and a storage container separably received in the storage compartment, the control method including applying a discoloration material, which changes color in accordance with a temperature, to a surface of the storage container, sensing a temperature of the storage container by detecting the received quantity of light, which varies in accordance with a color of the discoloration material; and controlling the temperature of the storage container by comparing the sensed temperature of the storage container with a preset temperature.

The sensing of the temperature of the storage container includes emitting light to the discoloration material, and detecting the received quantity of light reflected by the discoloration material, and sensing the temperature of the storage container in accordance with a voltage value, which corresponds to the detected received quantity of light.

The controlling of the temperature of the storage container includes maintaining the temperature of the storage container within a preset temperature range by operating a compressor when the temperature of the storage container is higher than the preset temperature range.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a perspective view illustrating a storage appliance according to an embodiment of the present invention;

FIG. 2 is a sectional view illustrating a configuration of the storage appliance according to the present invention;

FIG. 3 is a perspective view illustrating the outer appearance of a storage container according to an embodiment of the present invention;

FIG. 4 is a control block diagram of the storage appliance having a temperature sensing arrangement according to an embodiment of the present invention; and

FIG. 5 is a flow chart illustrating a control method of the storage appliance having a temperature sensing arrangement according to an embodiment of the present invention.

### DETAILED DESCRIPTION OF THE PREFERRED EMBODIMENTS

Reference will now be made in detail to the embodiment of the present invention, examples of which are illustrated in the accompanying drawings, wherein like reference numerals refer to like elements throughout. The embodiment is described below to explain the present invention by referring to the figures.

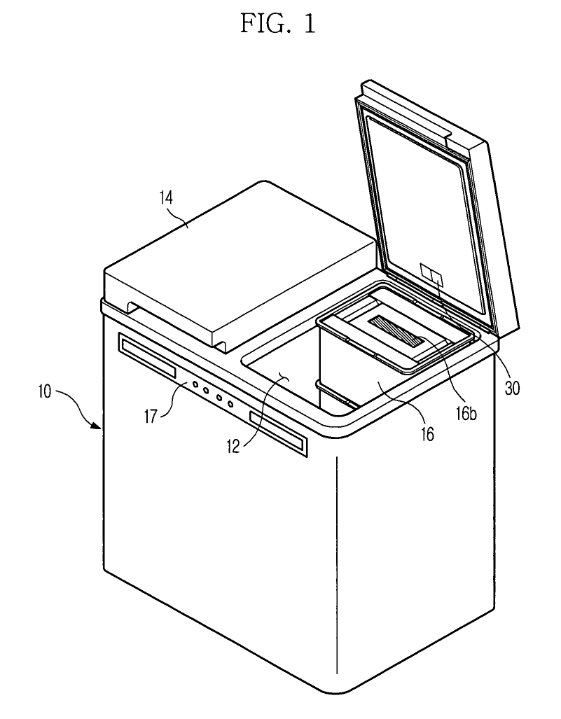

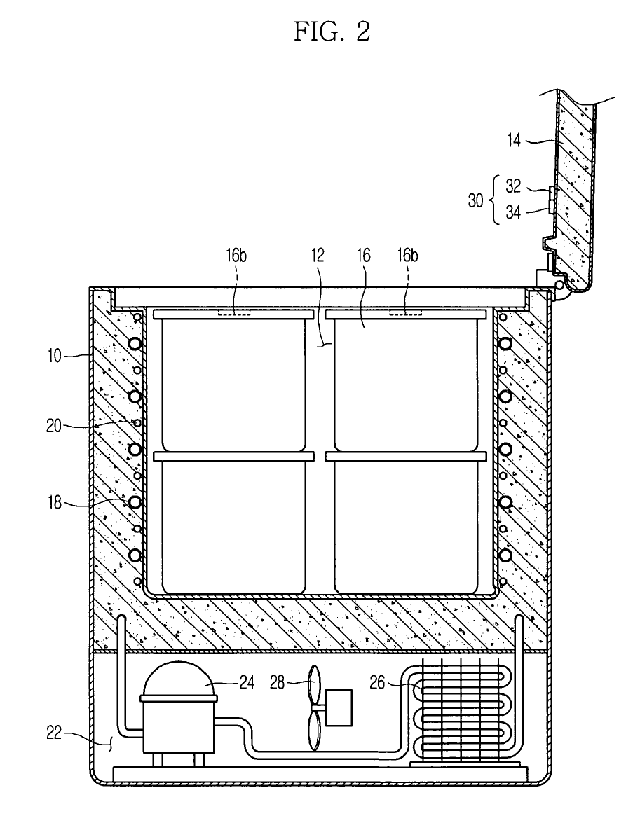

FIG. 1 is a perspective view illustrating a storage appliance according to the present invention, and FIG. 2 is a sectional view showing the configuration of the storage appliance according to the present invention.

As shown in FIGS. 1 and 2, the storage appliance of the present invention comprises a body 10 defined therein with an upwardly-opened storage compartment 12, and a door 14 pivotally coupled to the top of the body 10 to open and close the top of the storage compartment 12. A plurality of storage containers 16, in which kimchi, etc., is held, are separably received in the storage compartment 12.

The body 10 is formed of a conventional thermal insulating wall body that is filled with a foamed thermal insulating material. Similarly, the door 14 has a thermal insulating structure. An evaporator 18, which is formed of a typical refrigerant tube, is arranged on an outer surface of the storage compartment 12 to cool the storage compartment 12. A heater 20, which is formed of a typical electric heating wire, is also arranged on the outer surface of the storage compartment 12 to ferment kimchi. A machinery compartment 22, which is separate from the storage compartment 12, is formed in a lower portion of the body 10 to receive a compressor 24, condenser 26, fan 28, etc. In the illustrated case, a temperature sensing unit 30 is arranged on a lateral position of an inner surface of the door 14 to sense a temperature of an uppermost one of the storage containers 16.

The temperature sensing unit 30 comprises a light emitting element 32 and a light receiving element 34, and senses the temperature of the storage container 16 by detecting the quantity of light, which varies in accordance with a temperature variation of the storage container 16. It should be noted that the temperature sensing unit 30 is able to be installed at any position of a sidewall or bottom of the storage compartment 12 in accordance with the position of ink applied to the storage container 16.

A control panel 17 is arranged on an upper location of a front surface of the body 10, to display operating states, for example, a temperature of the storage container 16, or to allow a user to input desired operating conditions including a setting temperature. When being displayed on the control panel 17, the temperature of the storage container 16 is indicated in the color of a discoloration material, i.e. an ink film 16b, or in a digital temperature value, etc.

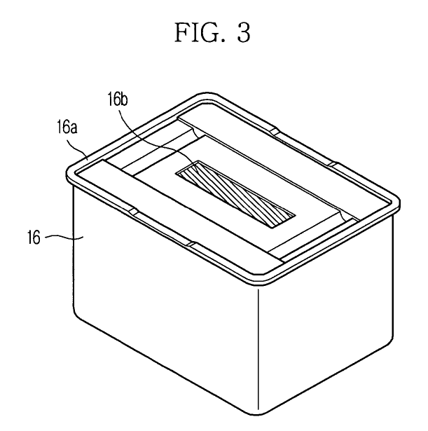

FIG. 3 is a perspective view illustrating an outer appearance of the storage container according to an embodiment of the present invention.

In FIG. 3, the ink film 16b is attached to a cover 16a of the storage container 16. To the ink film 16b is applied a special ink, which changes color in accordance with a temperature variation, so that the color of the ink film 16b varies in accordance with the temperature variation of the storage container 16.

The ink, which changes color in accordance with a temperature variation, is a pigmented liquid used especially for temperature measurement, and consists of a compound that will be discolored at a specific temperature or a phase variable compound. That is, the ink is a discoloration material comprising a variety of discoloration points over a wide range and, thus, is usable for various purposes, for example, for preventing overheating of electric appliances or measuring the temperature variation and temperature distribution on the surface of an article. The use of the discoloration ink is a well known conventional technique.

The attachment position of the ink film 16b is freely selectable from among any positions of the sidewall or bottom of the storage container 16 in accordance with the installation position of the temperature sensing unit 30.

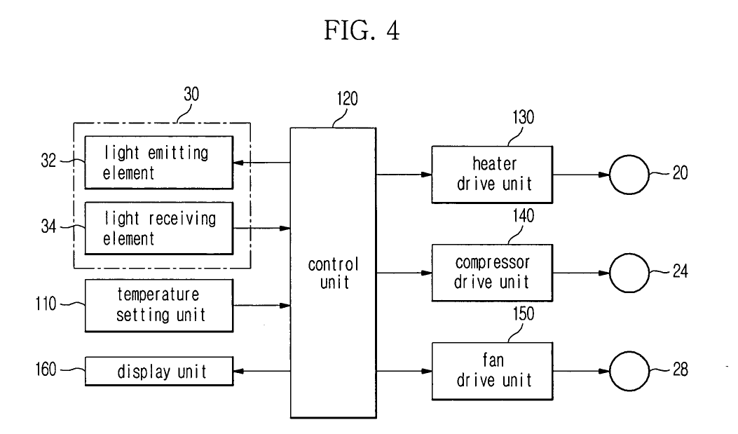

FIG. 4 is a control block diagram of the storage appliance having a temperature sensing arrangement according to an embodiment of the present invention. A control system of the storage appliance comprises the temperature sensing unit 30, a temperature setting unit 110, a control unit 120, a heater drive unit 130, a compressor drive unit 140, a fan drive unit 150, and a display unit 160.

The temperature sensing unit 30 senses a temperature variation of the storage container 16 based on the color of the ink film 16b. The temperature sensing unit 30 includes the light emitting element 32 and the light receiving element 34. When the light emitting element 32 emits light by a predetermined interval under control of the control unit 120, the light from the light emitting element 32 is reflected by the ink film 16b applied to the storage container 16. The light receiving element 34 receives the reflected light and detects the received quantity of light. The temperature sensing unit 30, consequently, inputs a voltage value corresponding to the received quantity of light, into the control unit 120.

The temperature setting unit 110 allows a user to set a temperature of the storage compartment 12, more specifically, a temperature of the storage container 16, to a desired value. The control unit 120 estimates a temperature of the storage container 16 corresponding to the voltage value inputted from the temperature sensing unit 30 and, then, compares the estimated temperature with the preset temperature inputted from the temperature setting unit 110, thereby serving to control On/Off operations of the compressor 24 and fan 28, based on the compared results.

The control unit 120 is provided with a timer to allow the light emitting element 32 to emit light by a predetermined interval, and is also provided with a ROM table containing preset temperature data of the storage container 16 corresponding to the voltage value inputted from the temperature sensing unit 30.

The heater drive unit 130, compressor drive unit 140, and fan drive unit 150 control On/Off operations of the heater 20, compressor 24, and fan 28 in accordance with heater control signals, compressor control signals, and fan control signals of the control unit 120, respectively.

The display unit 160 displays operating states of the storage appliance, for example, desired setting temperature, actual temperature of the storage container 16, etc., in accordance with display control signals of the control unit 120. In use, the display unit 160 indicates a varied color of the ink film 16b or a digital temperature value of the storage container 16.

Now, the operational sequence and effects of a control method of the storage appliance having the temperature sensing arrangement configured as stated above will be explained.

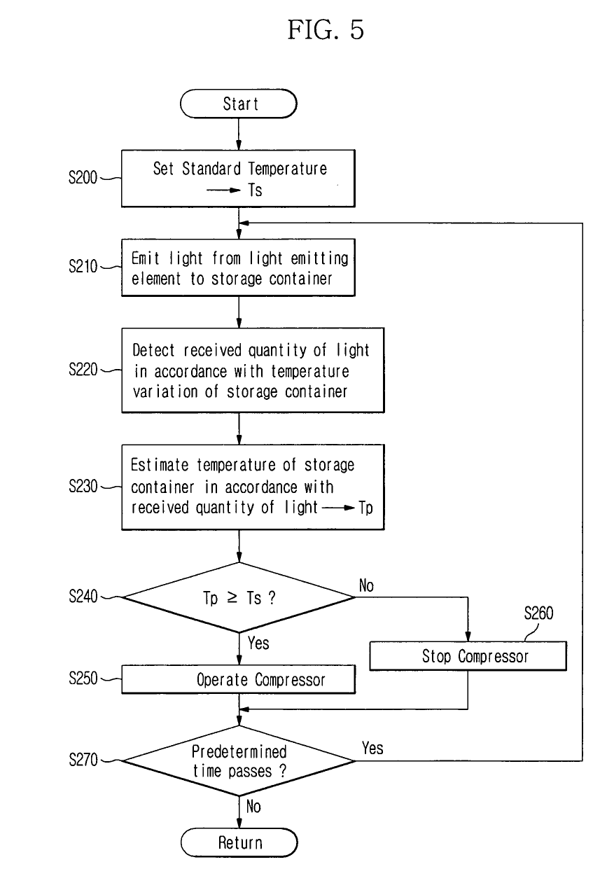

FIG. 5 is a flow chart illustrating the control method of the storage appliance having the temperature sensing arrangement according to an embodiment of the present invention.

The control method of the storage appliance according to the present invention will be described in conjunction with when the ink film 16b is applied to the cover 16a or outer peripheral surface of the storage container 16 that is separably received in the storage compartment 12, whereas the temperature sensing unit 30 is installed at the inner surface of the door 14 or inner peripheral surface of the storage compartment 12 at a position corresponding to the ink film 16b.

In operation 200, when a user sets a standard temperature Ts of a desired storage container 16 via the temperature setting unit 110, the standard temperature Ts is inputted from the temperature setting unit 110 to the control unit 120. Then the control unit 120 outputs a control signal for sensing a temperature of the storage container 16 to the temperature sensing unit 30.

From operation 200 the process moves to operation 210 where the light emitting element 32 of the temperature sensing unit 30 emits light to the desired storage container 16 by a predetermined interval under control of the control unit 120. From operation 210, the process moves to operation 220 where the light emitted from the light emitting element 32 is reflected by the ink film 16b applied to the storage container 16, so that the light receiving element 34 of the temperature sensing unit 30 receives the reflected light and detects the received quantity of light.

The ink film 16b applied to the storage container 16 changes color in accordance with the temperature of the storage container 16. Thus, the ink film 16b absorbs or reflects different amounts of light emitted from the light emitting element 32 in accordance with the color variation thereof, causing the light receiving element 34 to receive different amounts of light.

From operation 220, the process moves to operation 230, where when the temperature sensing unit 30 produces a voltage value corresponding to the quantity of light detected by the light receiving element 34, and inputs the voltage value to the control unit 120, the control unit 120 estimates a temperature Tp of the storage container 16 based on the inputted voltage value.

From operation 230 the process moves to operation 240, where the control unit 120 determines whether the estimated temperature Tp is higher than the preset standard temperature Ts. When it is determined that the estimated temperature Tp is higher than the preset standard temperature Ts in operation 240, the process moves to operation 250 where the compressor 24 is operated to cool the storage container 16 (S250).

Conversely, when it is determined that the estimated temperature Tp is lower than the standard temperature Ts in operation 240, the process moves to operation 260 where the operation of the compressor 24 is stopped to maintain the storage container 16 at the present temperature state.

Thus, on/off operations of the compressor 24 and fan 28 are controlled based on the compared results of the estimated temperature Tp and the standard temperature Ts, so that the storage container 16 can be maintained at a proper temperature.

From operation 250 and operation 260, the process moves to operation 270, where the control unit 120 measures a time to determine whether a predetermined time passes or not, to emit light for sensing a temperature of the storage container 16. When it is determined that the predetermined time passes in operation 270, the process returns to operation210 and repeats the process.

As apparent from the above description, a storage appliance having a temperature sensing arrangement and a control method thereof according to the present invention provides the following several effects.

In accordance with an embodiment of the present invention, ink, which changes color in accordance with a temperature, is applied to a storage container. Therefore, it is possible to sense a temperature variation of the storage container based on the color of the ink.

The present invention can control a temperature of the storage container at a proper value by detecting the received quantity of light, which varies in accordance with the temperature variation of the storage container. Also, the present invention has the effect of visually displaying the temperature variation of the storage container without using a separate thermometer.

Further, in the present invention, it is possible to sense a temperature of a specific space, which has a thermal insulating layer or is incapable of installing a temperature sensor.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A storage appliance having a temperature sensing arrangement, the storage appliance comprising a storage compartment and a storage container separably received in the storage compartment, the storage appliance comprising:
a discoloration material applied to the storage container to change color in accordance with a temperature of the storage container; and
a temperature sensing unit mounted in the storage compartment to detect a quantity of light received, which varies in accordance with the color of the discoloration material, to sense the temperature of the storage container.

2. The storage appliance according to claim 1, wherein the discoloration material is an ink film applied to a surface of the storage container.

3. The storage appliance according to claim 1, wherein the temperature sensing unit is installed at a position corresponding to the discoloration material.

4. The storage appliance according to claim 3, wherein the temperature sensing unit comprises:
a light emitting element to emit light; and
a light receiving element to detect the received quantity of light when the light, emitted from the light emitting element, is reflected by the discoloration material applied to the storage container to thereby be transmitted to the light receiving element.

5. The storage appliance according to claim 1, further comprising:
a display unit arranged on an outer surface of the storage appliance,
wherein the display unit displays the color of the discoloration material or a temperature value of the storage container.

6. The storage appliance according to claim 5, further comprising:
a control unit to estimate a temperature of the storage container when a voltage value, which corresponds to the received quantity of light, is transmitted from the temperature sensing unit to the control unit,
wherein the control unit controls the temperature of the storage container in accordance with the estimated temperature of the storage container.

7. A storage appliance having a temperature sensing arrangement, comprising a storage compartment, the storage appliance comprising:
a storage container separably received in the storage compartment;
a discoloration material applied to the storage container to change color in accordance with a temperature of the storage container;
a temperature sensing unit to detect a quantity of light received that varies in accordance with a color of the discoloration material, to sense the temperature of the storage container; and
a control unit to estimate a temperature of the storage container when a voltage value, which corresponds to the received quantity of light, is transmitted from the temperature sensing unit to the control unit.

8. The storage appliance according to claim 7, wherein:
the temperature sensing unit is mounted to an inner surface of a door that opens and closes the storage compartment; and
the temperature sensing unit comprises a light emitting element to emit light; and a light receiving element to detect the received quantity of light when the light, emitted from the light emitting element, is reflected by the discoloration material applied to the storage container to thereby be transmitted to the light receiving element.

9. The storage appliance according to claim 7, wherein the control unit controls the temperature of the storage container to a predetermined temperature in accordance with the estimated temperature of the storage container.

10. A control method of a storage appliance comprising a storage compartment and a storage container separably received in the storage compartment, the control method comprising:
applying a discoloration material, which changes color in accordance with a temperature, to a surface of the storage container;
sensing a temperature of the storage container by detecting a quantity of light received, which varies in accordance with a color of the discoloration material; and
controlling the temperature of the storage container by comparing the sensed temperature of the storage container with a preset temperature.

11. The control method according to claim 10, wherein the sensing of the temperature of the storage container comprises:
emitting light to the discoloration material, and detecting the received quantity of light reflected by the discoloration material; and
sensing the temperature of the storage container in accordance with a voltage value, which corresponds to the detected received quantity of light.

12. The control method according to claim 10, wherein the controlling of the temperature of the storage container comprises:
maintaining the temperature of the storage container within a preset temperature range by operating a compressor when the temperature of the storage container is higher than the preset temperature range.

13. An storage appliance having a storage container therein, comprising:
a sensor to sense a temperature of the storage container; and
a discoloration material applied to the storage container to change color in accordance with the temperature of the storage container.
